(19) United States
(12) Patent Application Publication
(10) Pub. No.: US 2011/0004491 A1
(43) Pub. Date: Jan. 6, 2011

(54) METHOD AND APPARATUS FOR MEDICAL RECORDKEEPING

(76) Inventor: Joseph Sameh, Chicago, IL (US)

Correspondence Address: CARDINAL LAW GROUP, LLC, SUITE 2000, 1603 ORRINGTON AVENUE, EVANSTON, IL, 60201, US

(21) Appl. No.: 12/883,000

(22) Filed: Sep. 15, 2010

Related U.S. Application Data
(63) Continuation-in-part of application No. 12/693,894, filed on Jan. 26, 2010.
Application No. 12/693,894 is a division of application No. 10/115,393, filed on Apr. 3, 2002, now Pat. No. 7,702,523.

(51) Int. Cl. G06Q 50/00; G06F 15/16

(52) U.S. Cl. 705/3; 709/206

(57) ABSTRACT

An apparatus for medical recordkeeping includes at least a first web server, at least a first processor in communication with the first web server, and a communications terminal connecting the web server with a network. The apparatus further includes at least a first memory in electrical communication with the processor. The first memory stores a plurality of medical records including at least a first entry indicative of a patient contact with at least a first service provider. Each successive patient contact is recorded onto the medical record responsive to the patient contact.

### RELATED APPLICATIONS

This application claims the benefit of, and priority to, U.S. patent application Ser. No. 12/693,894 filed Jan. 26, 2010 as a continuation in part application. The '894 application is a divisional application Ser. No. 10/115,393 filed Apr. 3, 2002, and therefore this application claims the benefit of, and priority to, the '393 application, which issued as U.S. Pat. No. 7,702,523. The entirety of each application is incorporated by reference herein.

### TECHNICAL FIELD

This invention relates generally to medical recordkeeping. The field of the invention relates to physician/patient contact and more particularly to methods of forwarding messages from a patient to a physician.

### BACKGROUND OF THE INVENTION

Good communication between doctor and patient has always been an important part of healthcare. While face-to-face communication has always been the best form of communication, it is also often necessary for physicians to remain available after hours for emergencies and other patient concerns.

The traditional method of contacting a physician after hours has been through an answering service. Answering services answer calls directed to the physician or their office and take messages. The physician may periodically call the answering service to pick up his messages. Alternatively, the answering service may contact the physician for each message, if the physician has a pager or other such communications device.

While answering services work well for taking and distributing messages, some calls could be handled without the physician's involvement. However, only the physician is qualified to make a decision regarding the handling of his patients by others.

Because of the variability of patient handling procedures among medical specialties, conventional systems are often not structured to incorporate the needs of the individual physician and his practice. Accordingly, a need exists for a method of processing patient contacts that can be structured to meet a variety of patient and provider needs. Medical record keeping can be a difficult burden for both patients and providers. Providers wish to receive important messages in a timely fashion, but not necessarily all messages have the same importance. Patients wish to communicate important information to their providers, but may not correctly understand the importance of the information, and may find the information of a different value than does the provider.

For example, a prescription refill may not be a matter of urgency for most situations, and a refill request call initiated to a physician at 3:00 in the morning may not justify a direct response from a physician. However, depending on certain circumstances, the same request for a prescription refill might be vitally important. For example, if a patient has gone through a prescription for pain medication quicker than would be expected, this could indicate other conditions. In another example, a call seeking an appointment, and complaining of abdominal pain may be indicative of indigestion, or may be indicative of a more serious condition in a patient who recently had abdominal surgery.

Additionally, it can be very important to know when contact was initiated and to track these contacts and/or outcomes. The ability to track phone calls and returned phone calls can help not only provide better care, but improve performance as well. However, current systems rely on user compliance and thus may suffer from error in both information entered, as well as inconsistent information entry.

Therefore, it would be desirable to provide an apparatus and method that overcomes the aforementioned and other disadvantages.

### SUMMARY OF THE INVENTION

A first embodiment of the invention provides an apparatus for medical recordkeeping that includes at least a first web server, at least a first processor in communication with the first web server, and a communications terminal connecting the web server with a network. The apparatus further includes at least a first memory in electrical communication with the processor. The first memory stores a plurality of medical records including at least a first entry indicative of a patient contact with at least a first service provider. Each successive patient contact is recorded onto the medical record responsive to the patient contact.

Another aspect of the invention provides a method of updating a medical record. The method includes receiving, at a central location, a plurality of message destinations, each message destination associated with at least one of a treatment provider and a service provider and receiving, at the central location, at least a first respective criterion for routing a message to each of the received message destinations based on a comparison between contents of a message and contents of a medical record. The method further includes receiving, at the central location, at least a first message, the message including at least one request; receiving, at the central location, at least a first medical record associated with the patient; parsing the message responsive to receiving the message; and parsing the medical record responsive to receiving the message. The method further includes determining a priority of the message based on the first respective criterion, routing the message to at least one of the treatment provider and the service provider responsive to the determined priority, and updating an electronic medical record responsive to the routing.

Another aspect of the invention provides a method of facilitating contact between a patient and at least one of a service provider and a treatment provider. The method includes receiving, at a central location, a plurality of message destinations, each message destination associated with at least one of a treatment provider and a service provider, and receiving, at the central location, at least a first respective criterion for routing a message to each of the received message destinations based on a comparison between contents of a message and contents of a medical record. The method includes receiving, at the central location, at least a first message, the message including at least one request, receiving, at the central location, at least a first medical record associated with the patient, parsing the message responsive to receiving the message, and parsing the medical record responsive to receiving the message. The method further includes determining a priority of the message based on the first respective criterion, routing the message to at least one of the treatment provider and the service provider responsive to the determined priority, updating an electronic medical record responsive to the routing, and facilitating a communication between the patient and the one of the service provider and the treatment provider responsive to the routing.

The aforementioned and other features and advantages of the invention will become further apparent from the following detailed description of the presently preferred embodiments, read in conjunction with the accompanying drawings, which are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram of a website messaging system under an illustrated embodiment of the invention;

FIG. 2 is a physician selection screen that may be used by the system of FIG. 1;

FIG. 3 is a classification screen that may be used by the system of FIG. 1;

FIG. 4 is an existing patient screen that may be used by the system of FIG. 1;

FIG. 5 is a new patient screen that may be used by the system of FIG. 1;

FIG. 6 is a pharmacist screen that may be used by the system of FIG. 1;

FIG. 7 is a medical staff screen that may be used by the system of FIG. 1;

FIG. 8 is a priority selection screen that may be used by the system of FIG. 1;

FIG. 9 is a key word entry screen that may be used by the system of FIG. 1;

FIG. 10 is a routing priority screen that may be used by the system of FIG. 1;

FIG. 11 illustrates an apparatus in accordance with an aspect of the invention;

FIG. 12 illustrates an apparatus in accordance with an aspect of the invention;

FIG. 13 illustrates an apparatus in accordance with an aspect of the invention;

FIG. 14 illustrates an apparatus in accordance with an aspect of the invention;

FIG. 15 illustrates an apparatus in accordance with an aspect of the invention;

FIG. 16 illustrates a method in accordance with an aspect of the invention; and

FIG. 17 illustrates a method in accordance with an aspect of the invention.

### DETAILED DESCRIPTION OF THE PRESENTLY PREFERRED EMBODIMENTS

FIG. 1 is a block diagram of a website messaging system 10 shown generally in accordance with an illustrated embodiment of the invention. The website messaging system 10 may be used to forward messages from patients to their attending physicians under any of a number of predetermined message formats and patient conditions specified by the attending physician.

The system 10 may also be used by associates of the physician (e.g., labs, pharmacies, etc.) to forward messages about patients to the attending physician. Because of the flexibility of the system 10 in handling messages the term “patient” or “requestor” is often used herein generically to refer to any of patients, associates of the physician or to other physicians passing messages through the system 10.

The system 10 may include a number of different interfaces 40, 42, 44. A first interface 40 may function as a patient interface that is able to provide information to and receive information from a patient 20, 22. One of the primary functions of the patient interface 40 is to identify a patient's attending physician and to function as an interface between the patient and the identified attending physician from among the many other physicians that may also use the system 10.

A second interface 42 may function as a processing center interface. The processing center interface 42 may function to receive information from the patient 20, 22 and determine a priority of the message.

A third interface 44 may function as the physician interface 44. The physician interface 44 functions to deliver the messages based upon the determined nature of the request and a set of delivery instructions provided by the physician.

The physician interface 44 may include a number of physician's records 58, 64, including one record for each physician using the system 10. Each record 58, 64 may include a physician's priority criteria 62, 68 and also a set of physician's routing instructions 62, 68 for routing requests to the physician.

The physician interface 44 may function to deliver messages to physicians under any of a number of communication formats (e.g., Internet, voice channel through the public switched telephone network (PSTN), voice channel through a cellular system, data through a cellular system, pager, palm pilot etc.). Because of the multiplicity of communication channels through which a request may be delivered, a communication sphere 24, 26 may be defined for each physician.

The communication sphere 24, 26 may be defined in a metaphysical sense as the physical space proximate the physician that may contain one or more communication devices. For example, if a first physician and his associated communication sphere 24 (the physician and communication sphere sometimes referred to hereinafter, together, as the “physician 24”) were located in his office (either in his home or in his clinic), then he may have access to a computer terminal 28, a telephone console 32 and a cell phone 36, all at the same time. In this case, the communication sphere 24 of the first physician may include the computer terminal 28, the telephone console 32 and the cell phone 36, as shown in FIG. 1.

If the physician 24 should leave his office and take his cell phone 36 with him, then the physician's communication sphere 24 may include the cell phone 36. Further, if the first physician 24 should leave his office and enter the office of a second physician 26, then the communication sphere 24 of the first physician may also include the communication devices 30, 34, 38 that are also within the communication sphere 26 of the second physician.

In order to accommodate the mobile nature of physicians, the physician interface 44 may be easily altered to include the changing range of communication devices located within the communication sphere 24, 26 of the physician. It should also be noted that the physician interface 44 may be altered to include the communication devices subscribed to by the physician or the communication devices of other physicians or non-physicians. In addition, while only two communication sphere 24, 26 are shown in FIG. 1, any number of spheres 24, 26 and any number of communication devices 28, 30, 32, 34, 36, 38 may be accommodated by the system 10.

Turning first to the patient interface 40, an explanation will first be offered of the interface 40 and how it functions to collect relevant information. Following a description of the patient interface 40, an explanation will be provided of the processing center interface 42 and of the physician interface 44.

In order to facilitate the simple and convenient use of the patient interface 40, the interface 40 may allow a patient 20, 22 to contact his physician through a web site (e.g., with a URL of “NeedMyDoctor.com”). Contacts through the web site 46 may be routine (e.g., making an appointment, obtaining a renewal of a prescription, etc.) or on a more urgent basis (e.g., an emergency).

Identification of a patient's physician may be accomplished automatically in the case of an existing patient by storing an identifier of the attending physician as a cookie in a browser of a computer terminal 20, 22 of the patient. In the alternative, new patients may be offered the opportunity to select a physician based upon the needs and preferences of the patient 20, 22.

Upon accessing the web site 46, an identity processor 48 may attempt to identify the patient 20, 22. Identification of the patient 20, 22 may be accomplished by retrieving a URL of the party accessing the web site 46 or by retrieval of any cookies present within the browser of the accessing party 20, 22. In either case, the URL or cookies may be compared with the contents of a set of customer records 50 to identity any physicians that the patient 20, 22 may have previously selected. In certain embodiments, the web site 46 may be protected by at least one security device configured to authenticate users and provide for secure authentications and communications.

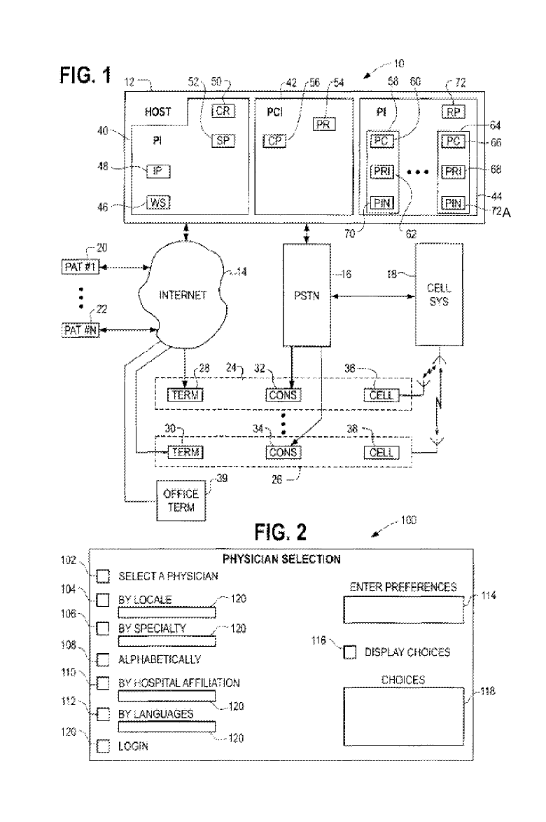

In either case, a screen (web page) 100 (FIG. 2) may be downloaded to a browser of the patient or other requester 20, 22. If the patient 20, 22 has previously used the system 10 and has previously selected a physician, then any selected physicians may be displayed within a CHOICES box 118.

If the patient 20, 22 has previously used only a single physician, then a name, image and biography of the physician may be displayed in the choice box 118. The patient 20, 22 may select this physician by activating a SELECT A PHYSICIAN button (softkey) 102 or by activation of an ENTER button on their terminal 20, 22.

If the patient 20, 22 has previously used or selected more than one physician, then a list of the names of previously selected physicians may be displayed in the CHOICES box 118. The patient 20, 22 may either select a physician from among those displayed in the CHOICES box 118 or select yet another physician by activation of one or more criteria selection boxes 104, 106, 108, 110, 112. If the patient 20, 22 selects from among the list of previously selected physicians within the box 118, then a name and image of the physician may be displayed and the patient 20, 22 may be proceed as described above.

If the patient 20, 22 chooses to select another physician, then he may select the other physician based upon any of a number of different criteria (e.g., locale, medical specialty, hospital affiliation, language ability, etc.). Further, the patient 20, 22 may refine their search by using a preferences window 114.

For example, the patient 20, 22 may enter an “A” in the preferences window 114 and activate a LOCALE button 104. Alternatively, the patient 20, 22 may activate the LOCALE button 104, enter an “A” in the box 114 and select the DISPLAY CHOICES button 116. In response, a selection processor 52 within the patient interface 40 may provide the patient with a set of choices on locale that begin with “A” (e.g.: Alabama; Alaska; Albany, N.Y. etc.).

The patient 20, 22 may make a selection and proceed to another search criteria. Upon making a selection, the selection may appear in a criteria display 120 associated with the criteria.

If the patient 20, 22 should then activate the BY HOSPITAL AFFILIATION button 110, then a list of hospitals in the selected locale may be displayed in the CHOICES box 118. As above, the patient 20, 22 may make a selection and the selection may appear in the box 120 associated with the selected criteria.

The patient 20, 22 may then select a specialty and, possibly a language preference. The patient 20, 22 may then select an ALPHABETICALLY button 108 to view a list of physicians under the combination of criteria chosen. The patient 20, 22 may select a physician from the list shown in the CHOICES area 118 and activate the SELECT A PHYSICIAN button 102 to complete the process.

As a much simpler alternative, the patient may simply enter a physician's name in the ENTER PREFERENCES box 114 and activate the SELECT A PHYSICIAN box 102. The name and image of the physician may appear in the CHOICES box 118. The patient 20, 22 may then review their choice and then activate the SELECT A PHYSICIAN box 102 a second time to complete selection of the physician.

The ability to enter a physician's name is a tremendous advantage for people who are traveling and experience a medical problem. In this case, the requester 20, 22 may simply go to any computer and access the website 46 remotely.

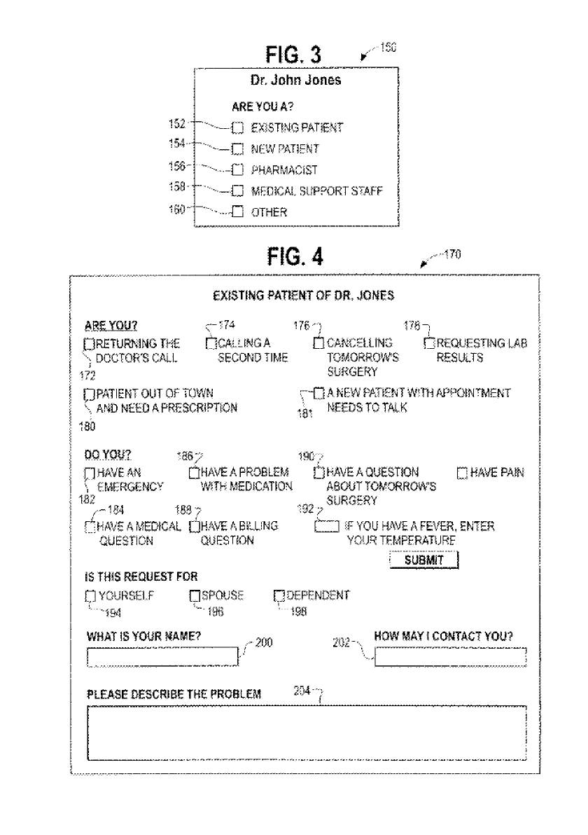

Following selection of a physician, the web page 150 (FIG. 3) may be downloaded to the patient 20, 22. Included within the web page 150 may be a number of classification buttons 152, 154, 156, 158, 160 for each message. While any method of classification may be used one method divides the messages according to whether the source is an existing patient, a new patient, medical support staff or other. Activation of an EXISTING PATIENT button 152 may be used to indicate that the patient 20, 22 is already under the care of the physician. Activation of an NEW PATIENT button 154 may be used to indicate that the patient 20, 22 has never seen the physician. Activation of the PHARMACIST button 156 may be used to indicate that the requester 20, 22 may be a pharmacist with a question about a prescription. Activation of the MEDICAL SUPPORT STAFF button 158 may indicate a message from another physician or a message from a person providing support services to the physician. Finally, activation of the OTHER button 158 may be used for any other purpose selected by the physician.

If the patient 20, 22 should activate the EXISTING PATIENT button 152, then the screen 170 of FIG. 4 may be downloaded to the patient 20, 22. Within the screen 170, a first set of boxes (softkeys) 172, 174, 176, 178, 180, 181 may be provided for entering an overall reason for the message. A second set of boxes 182, 184, 186, 188, 190, 192 may be provided for determining a physical state of the patient. A text entry window 192 may be provided for entry of a patient temperature.

Another text box 200 may be provided for entry of a name of the requestor 20, 22. A text box 202 may also be provided for entry of a communication path (e.g., telephone number, e-mail address, pager number, etc.) through which the physician can reach the requester 20, 22. The requester 20, 22 may also be able to identify through a set of softkeys 194, 196, 198 whether the requester is the patient or whether the patient is a relative. A text box 182 may be provided for entry of a description of the problem.

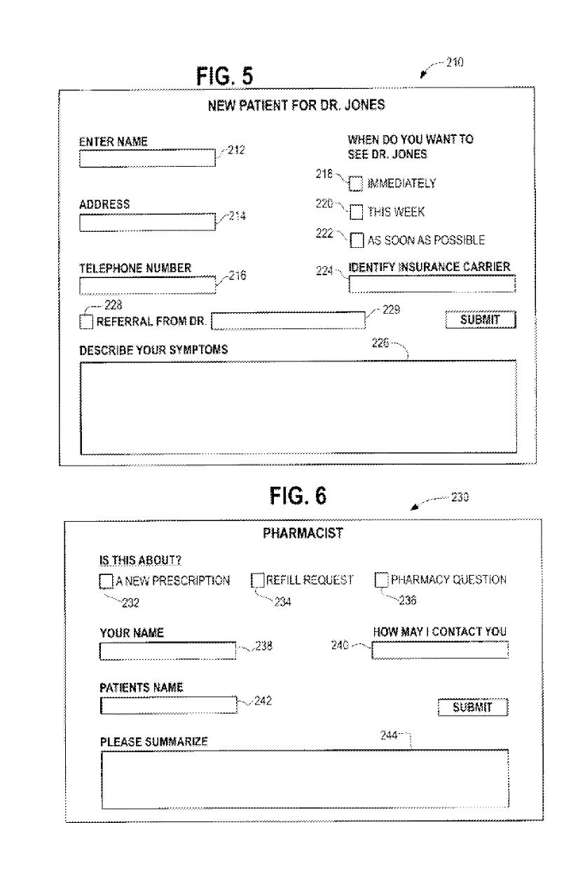

If the patient 20, 22 should activate the NEW PATIENT softkey 154, then a screen 210 of FIG. 5 may be downloaded to the requester 20, 22. Text boxes 212, 214, 216 may be provided for entry of a name, address and contact information of the patient. A softkey 228 and textbox 229 combination may be used to identify the patient as a referral and the source of the referral. Selection buttons 218, 220, 222 may be provided for scheduling an appointment. A text box 224 may be provided for entry of insurance information. Finally, a large text box 226 may be provided for entry of descriptive information regarding the reason for the appointment.

If the requester 20, 22 should activate the PHARMACIST softkey 156 on FIG. 3, then the screen 230 of FIG. 6 may be downloaded to the requester 20, 22. Within the screen 230, the requester 20, 22 may be provided with text boxes 238, 240 for identification of the requester and to enter contact information. A set of softkey boxes 232, 234, 236 may be provided for the requester to differentiate between questions about new prescriptions, refills and general pharmacy questions.

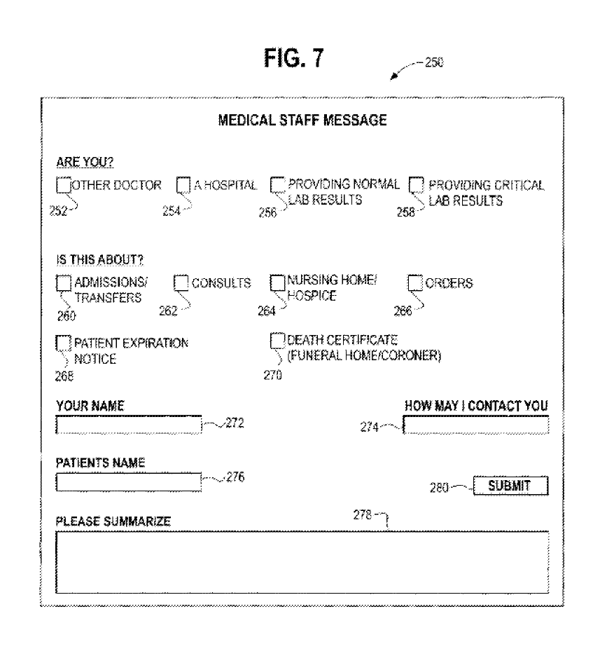

If the requester 20, 22 should activate the MEDICAL SUPPORT STAFF button 158, then the screen 250 of FIG. 7 may be downloaded to the requester 20, 22. Within the screen 250, the requester 20, 22 may be asked to enter their name and contact information in one set of boxes 272, 274. Another set of boxes 252, 254, 256, 258, 260, 262, 264, 266, 268, 270 may be provided for entry of a context of the request.

In addition, a text box 276 may be provided for entry of a patient's name. Another text box 278 may be provided for entry of a message regarding the patient. A SUBMIT button 280 allows the requester 20, 22 to return the message to the system 10.

If the requester 20, 22 should activate the OTHER box 158, then a single blank text box may be downloaded. The OTHER button 158 may be used for any of a number of purposes as described in more detail below.

Upon completion of selection of a physician and of the entry of information through the text boxes of FIGS. 3-7, the message may be transferred to the processing center interface 42. Within the processing center interface 42, a content processor 56 may process each message to determine a nature and content of the request based upon the information elements provided through the web pages (e.g., the identity of the requester, any classification information provided through the classification buttons and any text information received through the text boxes).

Based upon the determined nature and content of the request, a relative importance may be assigned to the request, based upon a subjective criteria provided by the physician. The criteria is necessarily subjective because the relative importance of information elements varies from one physician's practice to another physician's practice and in accordance with the preferences of one physician over another physician. Additionally, the criteria may vary responsive to a patient's varying health.

For example, physicians with a practice limited to surgery may only classify messages from hospitals or other surgeons or patients with post operative problems as significant enough to justify an expedited message to the physician. Other messages to the surgeon may be regarded as much less important.

In the alternative, a physician with a practice limited to pediatric care may only consider children with high fevers, broken bones or severe bleeding as important. Other requests related to less severe trauma may be considered to be less important. Further the criteria for routing messages to a physician may be changed based upon the time of day. Alternatively, the criteria for routing messages may be based on the open or closure of the office.

For example, during normal office hours, all messages may be routed to a nurse or other assistant at a clinic or hospital where the physician is normally to be found during those hours. After normal office hours, messages may be routed to the physician only when the physician is on call. When the physician is not on call, any requests to the physician may be automatically routed to another designated physician. Alternatively, when the physician is not on call, any requests to the physician may be automatically routed to another designated physician communication sphere.

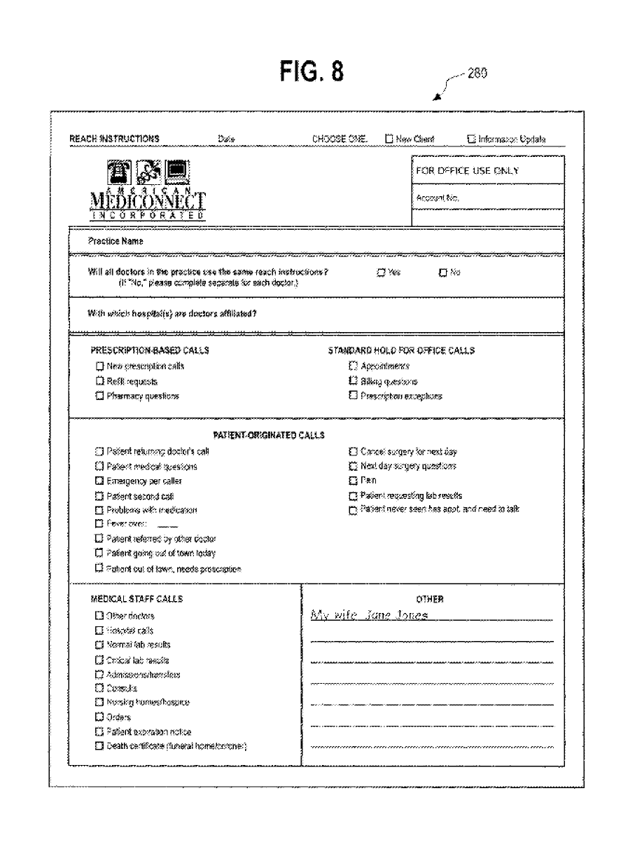

Based upon the nature of the request, the content processor 56 may route the message, by comparing an information content with a set of threshold values provided by the physician. FIG. 8 provides a screen 280 that may be downloaded to a terminal 28, 30 of a physician 24, 26 for purposes of setting threshold values for forwarding messages. The screen 280 may be downloaded to a physician during initial registration with the system 10 or at any time thereafter to change the routing format.

The screen 280 of FIG. 8 may be used by the physician to establish a multi-level message forwarding methodology. Under one embodiment, the box shown along the left side of each subject matter listing in screen 280 may be a text box where a number value indicating priority may be explicitly entered. For purposes of simplicity, the system 10 will be described as being based upon a two-level system of priorities. However, any number of priority levels could be used.

Also, for purposes of simplicity, the use of the screen 280 will be described using a system of default levels. Instead of entering a number in the box, the boxes may be used as softkeys. If the softkey is activated by the physician, then the subject matter of that softkey will be given the highest priority. If the softkey is not activated, then the subject matter will be given the second, lower level of priority.

At a highest, first level of importance, messages may be routed directly to a physician's sphere 24, 26. At the second level, requests may be routed to a secondary destination (e.g., an office of the physician).

For example, checking the box in the upper left corner (labeled “New prescription calls”) would result in all messages from pharmacists, or others, about new prescriptions being given the highest priority and routed directly to the physician. Further, checking the box in the bottom of the right-side (labeled “Patient never seen has appt. and need to talk”) would result in messages from first time patients begin routed on the first level.

In general, the solicitation and processing of messages from requesters 20, 22 within the content processor 56 may be controlled by a physician's criteria obtained by the system 10 through screen 280 and stored in a file 60, 66 for each physician. Once a physician 24, 26 has identified a routing criteria (e.g., using screen 280), the content processor 56 may retrieve the routing criteria for that physician 24, 26 and use the criteria for message routing.

As each webpage 150, 170, 200 is completed and returned to the system 10, the content processor 56 may examine the content of the webpage 150, 170, 200 under the criteria provided by the associated physician 24, 26. A determination of the nature and importance of the message may occur on any of a number of different levels.

On a first level, the processor 56 may determine the type of message based upon the information elements provided through screens 170, 210, 230, 250. Following a determination of the type of message, the content processor 56 may perform an element-by-element comparison between selected items for that message type on screen 280 and the content of the message.

The message type of STANDARD HOLD FOR OFFICE CALLS would always be classified as a low priority unless the physician indicated otherwise. If the physician has selected “Appointments”, then messages from new patients where the softkey 154 is activated would be given a high priority. The selections for “Billing questions” and “Prescription exceptions” may be given similar treatments.

Messages from patients may be processed somewhat differently. For example, a physician may not only select the option “Fever over ______”, but may also specify a priority limit for the fever. Detection may be accomplished by a comparison of the numeric value entered through the text box 192 and the threshold value provided by the physician. Alternatively, the physician may specify any fever within one week post operatively. Alternatively, other relevant comparators may be used for the processing determination.

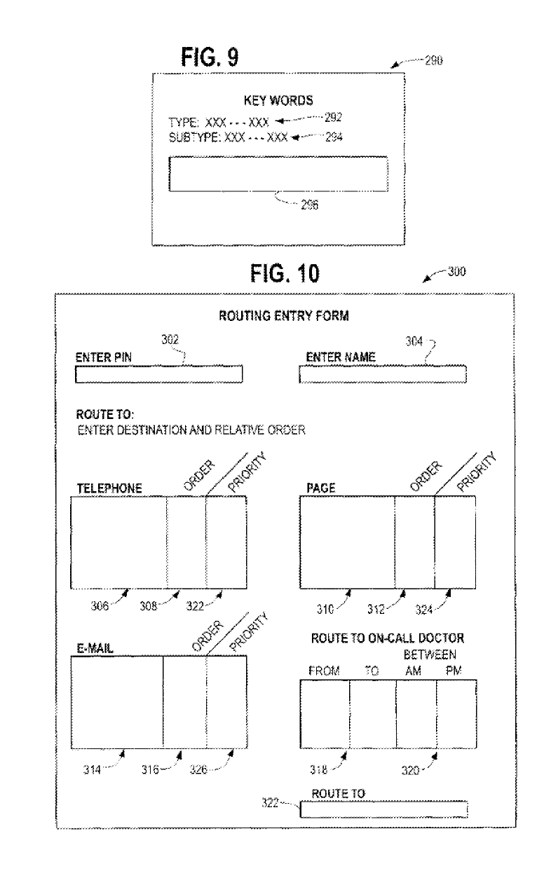

On another level, the physician 24, 24 may also set a criteria for message routing based upon key word searching using words entered through any of the text boxes 202, 204, 226, 238, 242, 244, 272, 272, 276, 278. For example, the physician 24, 26 may go to screen 280 of FIG. 8 and double click on any element or sub-element to bring up a text box associated with that element. For example, the physician 24, 26 may double click on the “OTHER” category on screen 280. In response, the text box 290 of FIG. 9 may be downloaded to the physician's terminal 28, 30. Within the text box 290, a first line 292 may indicate the type of text box as being “OTHER”. Since the “OTHER” category does not have a sub-element, the second line 294 may be blank.

Upon entering the text box 290, the physician 24, 26 may enter his wife's name (e.g., “Jane Jones”) or some other word identifying his wife. Entry of his wife's name as a criteria for the “OTHER” category allows any message sent under the “OTHER” classification and that includes his wife's name or identifier to be given a high routing priority.

To use the facility, the physician's wife would enter the web site 46, type her husband's name in text box 114 and activate “SELECT A PHYSICIAN”. On the next downloaded screen 150, the wife would select “OTHER”. In response, a blind screen would appear within which the physician's wife may type “From: Jane Jones” and a message. Upon receiving the message, the content processor 56 would compare the key words “Jane Jones” with the content of the message and recognize the matching words “Jane Jones” present in the message header. Based upon the match, the content processor 56 would route the message at the highest priority level.

Alternatively, the physician may also click on “PATIENT-ORIGINATED CALLS” on screen 280 and enter a patient's name. Based on key word searching, any message from that patient would be routed at the highest priority.

The use of key word searching allows a physician to customize call routing for any time period (e.g., 2 hours, 2 days, permanently, etc.) to meet the needs of critically ill patients. Alternatively, if the physician is part of a surgical team waiting for a transplant donor, key word searching could be used to automatically identify messages from other members of the surgical team. Alternatively, the time period can be associated with a particular event, such as a surgery or other treatment, such as one week post surgery, 24 hours past a transplant or the like.

Once the content processor 56 determines an information content and priority level of a message, the content processor 56 may transfer the message to a routing processor 72 within the physician's interface 44. Within the physician's interface 44, the routing processor 72, may retrieve a set of routing instructions 68 based upon the priority level determined by the content processor 56.

Located within the routing instructions 68 may be a prioritized list of communication devices within the physician's communication sphere 24, 26. Messages may be routed to the physician 24, 26 based upon the entries within the prioritized list.

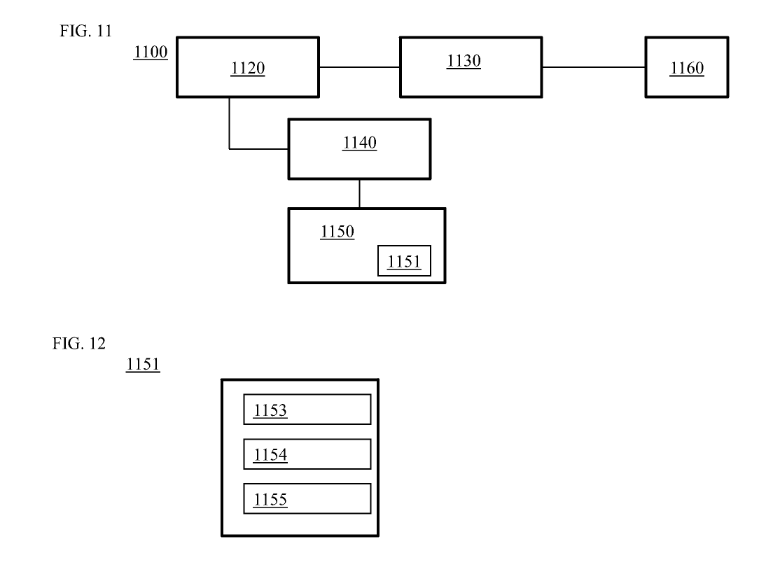

FIG. 10 depicts a routing webpage 300 that may be downloaded from the web site 46 to a terminal 28, 30 of the physician. The routing webpage 300 may be accessed by first accessing the physician identification webpage 100 (FIG. 2) and activating LOGIN softkey 120.

Within the webpage 300, the physician may first be required to enter his personal identifier number (PIN) into a first box 302. Upon entering his PIN number the terminal 28, 30 may upload the PIN to the routing processor 72 where the PIN is compared with the PINs 70, 72A of other physicians using the system 10.

If a match is found, the routing processor 72 may download a name of the physician to be displayed in a first box 304 and a current content of the physician routing instructions 62, 68 to be displayed in other boxes 306, 310, 314.

Included with each routing destination is an ordering number 308, 312, 316 and priority ranking 322, 324, 326. The ordering number indicates the relative position of the routing destination in the routing list for any particular priority level. For example, at the highest priority level, if the physician wishes to be paged first, then the pager number would appear at a top of a list in box 310 with a number “1” shown opposite the pager number in an order list 312 and a “1” in the priority ranking. If the physician wishes to simultaneously receive a hardcopy of the message on his computer 28, 30, then an e-mail address of his computer may appear on the top of list in an e-mail box 314 opposite another number “1” in the order box 316 and a “1” in the priority ranking. Once the physician downloads the screen 300, they may make new entries, delete old entries or change the order at will.

In addition to setting up a routing list, the physician 24, 26 may also set up a schedule when he/she is not to receive messages (i.e., the physician is not on call). As shown, the physician simply enters his dates and hours when the physician is not on call and when calls should be routed to another physician. The entry of time periods into boxes 318, 320 simply causes messages to be routed to an alternate physician in an on call list maintained within the system 10. An identifier of the alternate physician may be entered into a “ROUTE TO” text box 322.

Delivery of the messages may occur under any of a number of different formats. For example, if the physician's computer 28, 30 is the destination of a message, then the delivered message may have the same format as shown in FIGS. 2-7. Alternatively, the format of FIGS. 2-7 may be changed to delete unnecessary information.

If the destination is a cell phone or a telephone, then a voice synthesizer may be used to present the messages of FIGS. 2-7 under a predefined audio format. Alteration of the call list based upon screen 300 may also be accomplished using a telephone, the voice synthesizer and keypad selection on the telephone.

Once a message has been delivered to the physician 24, 26, the routing processor 72 may send a message back to the patient interface 40 and patient 20, 22 confirming receipt of a high priority message by the physician. Where the physician responds to the patient's message through the system 10, the routing processor 72 may also calculate an average time for the physician to respond. In such cases, the routing processor 72 may also include an estimate of the expected time for the physician to respond in the message to the patient 20, 22.

FIG. 11 illustrates a schematic view of an apparatus 1100 for medical recordkeeping. The apparatus 1100 includes at least a first web server 1120 and at least a first processor 1140 in communication with the first web server. A communications terminal 1130 connects the web server with a network 1160. At least a first memory 1150 is in electrical communication with the processor 1140 and the first memory stores a plurality of medical records 1151. Each medical record 1151 includes at least a first entry 1153 indicative of a patient contact with at least a first service provider, and wherein each successive patient contact 1154, 1155 is recorded onto the medical record 1151 responsive to the patient contact.

Network 1160 may be any appropriate network, including a POTS (Plain Old Telephone Service), or circuit switched network, as well as a packet switched network, such as a network operating on a protocol such as the Internet, or other such protocol driven data transmission network. The memory 1150 may be any appropriate memory device, including a transient memory, RAM, ROM, removable memory device, hard drive, fixed memory device, RAID system, or the like. The memory 1150 may store medical records 1151 responsive to a first form populated based on a patient contact, or the first form may be populated based on contact from an intermediary, such as a different service provider or a different healthcare provider.

The processor 1140 is any appropriate processor configured to receive instructions, process the instructions and issue instructions responsive to the processing. The processor 1410 may be an ASIC, or a general purpose controller programmed for the tasks to be performed.

The patient contact is any contact from a patient into a healthcare system, and may be received via a telephone call to an office or call center. Alternatively, the contact may be received via a networked portal with the portal connected to a network, such as a packet switched network operating with a packet switching protocol (such as the Internet) or a circuit switched network. Patient contacts via the telephone require a translation into a computer understandable format, such as a voice recognition program or a telephone call center with human agents. The patient contact may be received directly from the patient, or via a proxy, such as an insurance company, third party payor, non-treatment service provider, a data aggregator and a treatment provider.

FIG. 12 illustrates one embodiment of a medical record, such as medical record 1151 of FIG. 11. As illustrated in FIG. 12, medical record 1151 includes a first entry 1153 indicative of a patient contact with at least a first service provider. Additionally, medical record 1151 may include successive entries 1154, 1155 indicative of a patient contact with other service providers. The other service providers may be the same, or different service providers, or healthcare providers.

The terms “service providers” and “healthcare providers” are used in this application and have similar meanings. A “service provider” is defined herein as a person or organization that assists in providing healthcare services, but is not necessarily a licensed professional such as a physician or nurse. A “healthcare provider” is professional (such as a physician or nurse) or closely supervised by a professional, or is an organization, whose goal is to deliver healthcare services to patients. For example, a service provider could be a scheduler, answering service, or the like, whereas the healthcare provider is the doctor. While these specific examples of a “service provider” and “healthcare provider” are illustrative rather than limiting, the examples are intended to provide discrete examples of the types of persons described by the terms used herein. This document also refers to “treatment providers” which is defined as a person or entity that directly provides treatment to a patient. A single entity or person may be any of “treatment provider” and/or “healthcare provider” and/or “service provider” and wearing figurative different hats.

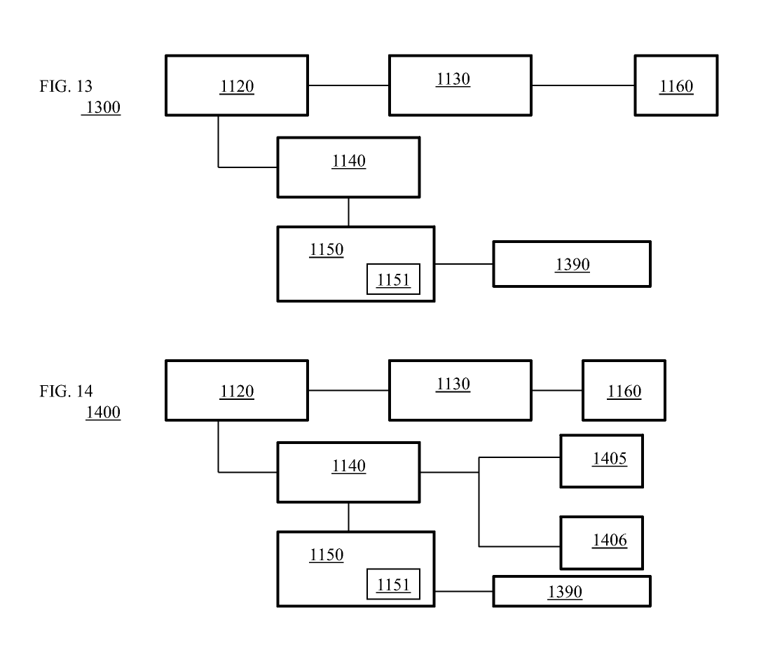

FIG. 13 illustrates an apparatus 1300 in accordance with another aspect of the invention. Apparatus 1300 is implemented similar to apparatus 1100, and like numbers in FIG. 13 indicate like structures in FIG. 11. FIG. 13 further illustrates an agent 1390 in communication with the memory 1150. Agent 1390 is an agent configured to parse the medical record (such as medical record 1151) and configured to parse the patient contact. Additionally, agent 1390 determines a priority level associated with the patient contact based on the parsed medical record and based on the parsed patient contact.

Agent 1390 is provided a set of rules intended to provide the basis for an informed estimate of a priority level of the communication. The priority level may be based on a number of patient contacts within a predetermined period of time, in one embodiment. In another embodiment, the priority level is based on a length of time between a first message and a second message. In another embodiment, the priority level is based on an identity of the patient. In another embodiment, the priority level is based on a medical condition of the patient as evidenced by the content of the medical record. In one such embodiment, the medical record may include a timer indicative of an escalated priority, or the timer can be configured to indicate an escalation of priority responsive to certain inputs but wherein this escalation is only for a predetermined and limited time span following another event. For example, a contact complaining of abdominal pain can trigger escalated priority in the 24 hours following a hospital discharge from abdominal surgery. In other embodiments, the criteria for determining a priority level is configurable based on the desires of the healthcare provider or the treatment provider.

FIG. 14 illustrates another embodiment of the invention as apparatus 1400. Apparatus 1400 is implemented similar to apparatus 1300, and like numbers in FIG. 14 indicate like structures in FIG. 13. FIG. 14 further illustrates at least a first treatment provider 1405 and a first service provider 1406 accessible to the apparatus 1400 via the network, and wherein the processor 1140 chooses one of the first treatment provider and first service provider responsive to the determined priority level. Alternatively, the system can include at least a first service provider and a second service provider accessible to the apparatus via the network, and the processor chooses one of the first service provider and second service provider responsive to the determined priority level.

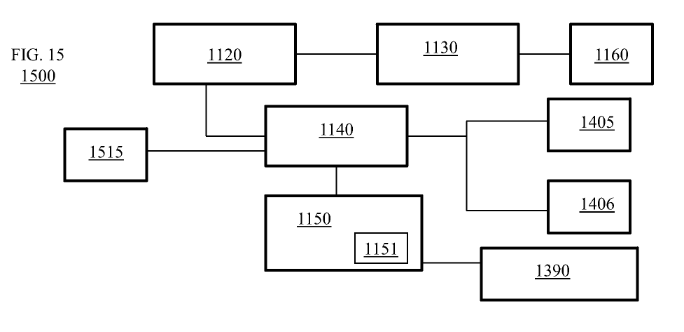

FIG. 15 illustrates an apparatus 1500 in accordance with another aspect of the invention. Apparatus 1500 is implemented similar to apparatus 1400 with like numbers associated with like structures. Apparatus 1500 further includes agent 1515 configured to transmit a first message to the patient responsive to one of the first treatment provider contact and the first service provider contact, and wherein the first message comprises an estimate of a time period during which one of the first treatment provider and the first service provider initiates contact with the patient.

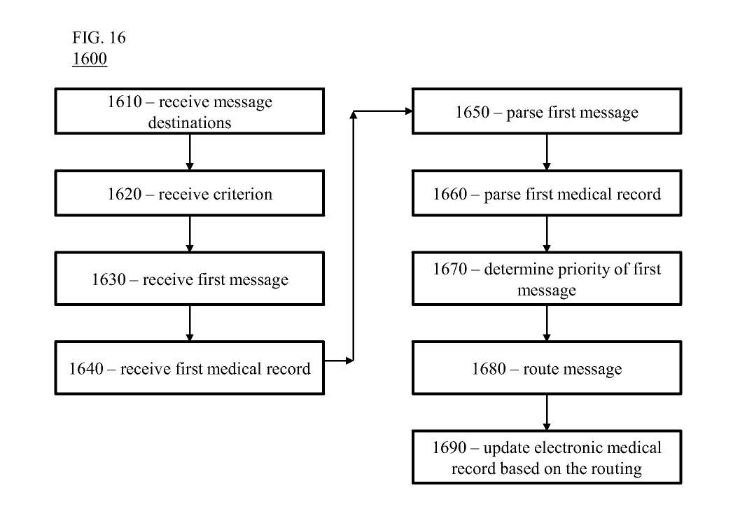

FIG. 16 illustrates a method 1600 of updating a medical record, in accordance with one aspect of the invention. Method 1600 includes receiving 1610, at a central location, a plurality of message destinations. During step 1610, each message destination is associated with at least one of a treatment provider and a service provider. The central location can be any location, discrete or distributed, where information is received, processed, and action taken responsive to the processed information. For example, the central location may be a web site, a data processing center, a service provider office, a treatment provider office, or the like.

Method 1600 continues at step 1620 by receiving, at the central location, at least a first respective criterion for routing a message to each of the received message destinations based on a comparison between contents of a message and contents of a medical record associated with a patient associated with the message. The criterion includes factors for determining a priority of the message as outlined further below. In one embodiment, the criterion includes a number of patient contacts within a predetermined period of time. In one embodiment, the criterion includes a length of time between a first message and a second message.

Method 1600 continues at step 1630 by receiving, at the central location, at least a first message, the message including at least one request. The message can be received via any appropriate input, such as a call center, website, packet switched network, circuit switched network or the like. The message includes a request for services for a patient to a healthcare provider, service provider of the like. The request can be a request for a prescription refill, an appointment request, treatment request, social call, personal call, sales call, or the like.

At step 1640, method 1600 includes receiving, at the central location, at least a first medical record associated with the patient. The medical record includes information indicative of prior contacts with the patient, such as a medical history, prescription history, laboratory test result history, imaging results, and other information that could be of interest to interested parties in the further care, treatment, or payment for the same, for the patient. At step 1650, method 1600 parses the message responsive to receiving the message and at step 1660 method 1600 parses the medical record responsive to receiving the message. In steps 1650 and 1660, method 1600 determines the contents of both the medical record and the message. Then, in step 1670, method 1600 determines a priority of the message based on the first respective criterion and the parsed contents. Based on the priority, method 1600 routes 1680 the message to at least one of the treatment provider and the service provider responsive to the determined priority. At step 1690, method 1600 updates an electronic medical record responsive to the routing. In one embodiment, updating the electronic medical record includes updating at least one of a time of message receipt, source of message, time of message routing, determined destination, determined priority; response time estimate; response time achieved; and parsed message contents. Updating the electronic medical record in such a fashion improves the completeness of the record by tracking contacts with the record.

In one embodiment, receiving the message includes receiving a phone call at an answering service and wherein updating an electronic medical record responsive to the routing comprises transcribing the message and writing the transcribed message to the electronic medical record. In one embodiment, receiving the message comprises at least one of receiving an electronic communication via a packet switched network, receiving an electronic communication via a circuit switched network, and receiving an over the air message. In yet another embodiment, updating an electronic medical record responsive to the routing includes storing a sound file in memory.

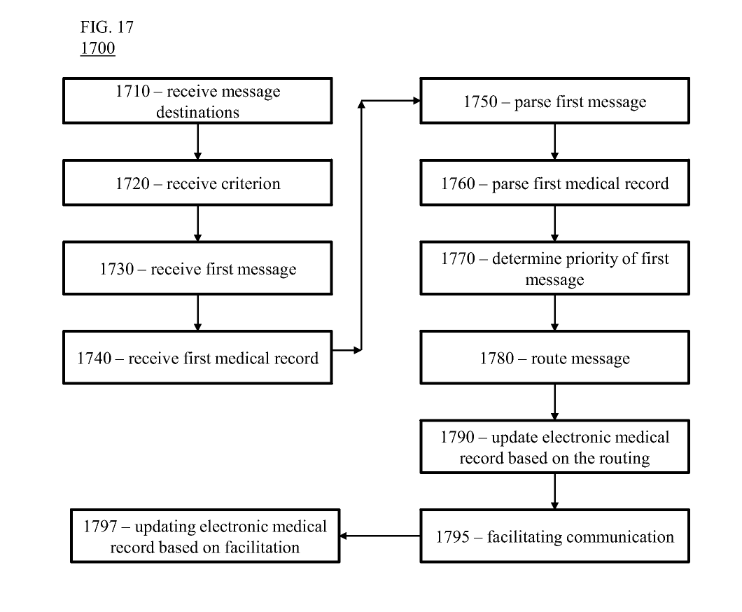

FIG. 17 illustrates a method 1700 of facilitating contact between a patient and at least one of a service provider and a treatment provider, in accordance with one aspect of the invention. Method 1700 includes receiving 1710, at a central location, a plurality of message destinations. During step 1710, each message destination is associated with at least one of a treatment provider and a service provider. The central location can be any location, discrete or distributed, where information is received, processed, and action taken responsive to the processed information. For example, the central location may be a web site, a data processing center, a service provider office, a treatment provider office, or the like.

Method 1700 continues at step 1720 by receiving, at the central location, at least a first respective criterion for routing a message to each of the received message destinations based on a comparison between contents of a message and contents of a medical record. The criterion includes factors for determining a priority of the message as outlined further below. In one embodiment, the criterion includes a number of patient contacts within a predetermined period of time. In one embodiment, the criterion includes a length of time between a first message and a second message.

Method 1700 continues at step 1730 by receiving, at the central location, at least a first message, the message including at least one request. The message can be received via any appropriate input, such as a call center, website, packet switched network, circuit switched network or the like. The message includes a request for services for a patient to a healthcare provider, service provider or the like. The request can be a request for a prescription refill, an appointment request, treatment request, social call, personal call, sales call, or the like.

At step 1740, method 1700 includes receiving, at the central location, at least a first medical record associated with the patient. The medical record includes information indicative of prior contacts with the patient, such as a medical history, prescription history, lab test results, imaging results, and other information that could be of interest to interested parties in the further care, treatment, or payment for the same, for the patient. At step 1750, method 1700 parses the message responsive to receiving the message and at step 1760 method 1700 parses the medical record responsive to receiving the message. In steps 1750 and 1760, method 1700 determines the contents of both the medical record and the message. Then, in step 1770, method 1700 determines a priority of the message based on the first respective criterion and the parsed contents. Based on the priority, step 1780 of method 1700 routes the message to at least one of the treatment provider and the service provider responsive to the determined priority. At step 1790, method 1700 updates an electronic medical record responsive to the routing. In one embodiment, updating the electronic medical record includes updating at least one of a time of message receipt, source of message, time of message routing, determined destination, determined priority; response time estimate; response time achieved; and parsed message contents. Updating the electronic medical record in such a fashion improves the completeness of the record by tracking contacts with the record.

At step 1795, method 1700 facilitates a communication between the patient and the one of the service provider and the treatment provider responsive to the routing. Facilitating the communication can include initiating a telephone call, initiating a chat session, sending an email, sending a MMS or text message, or other such initiation of contact. In some embodiments, method 1700 further includes step 1797, and updates the medical record based on the facilitated communication.

The configurations described herein can be accomplished using an interface within or connected to the apparatus, or, can be remotely accomplished. In embodiments allowing for a remote configuration, the apparatus may have an individual address or other manner of identification over a network, such as an IP address for devices attached to the Internet. In such embodiments, a user interface, such as a Graphical User Interface receives configuration instructions from a user and configures the apparatus based on the configuration instructions.

While the embodiments of the invention disclosed herein are presently considered to be preferred, various changes and modifications can be made without departing from the spirit and scope of the invention. The scope of the invention is indicated in the appended claims, and all changes and modifications that come within the meaning and range of equivalents are intended to be embraced therein. A specific embodiment of a method and apparatus for routing physician messages through a website has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention, any and all modifications, variations, or equivalents that fall within the true spirit and scope of the basic underlying principles disclosed and claimed herein.

What is claimed is:

1. An apparatus for medical recordkeeping, the apparatus comprising:
at least a first web server;
at least a first processor in communication with the first web server;
a communications terminal connecting the web server with a network;
at least a first memory in electrical communication with the processor, the first memory storing a plurality of medical records, each medical record including at least a first entry indicative of a patient contact with at least a first service provider, and wherein each successive patient contact is recorded onto the medical record responsive to the patient contact.

2. The apparatus of claim 1 wherein the medical record comprises at least a first form populated based on a patient contact.

3. The apparatus of claim 1 wherein the patient contact is received from one of the patient, an insurance company, a third party payor, non-treatment service provider, a data aggregator, and a treatment provider.

4. The apparatus of claim 1 wherein the medical record further comprises at least a second entry indicative of a first treatment provider contact with the patient, and wherein each successive first treatment provider contact is recorded onto the medical record responsive to the first treatment provider contact.

5. The apparatus of claim 4 wherein the medical record further comprises at least a third entry indicative of a second treatment provider contact with the patient, and wherein each successive treatment second provider contact is recorded onto the medical record responsive to the second treatment provider contact.

6. The apparatus of claim 1 further comprising an agent configured to parse the medical record and configured to parse the patient contact, and wherein the agent determines a priority level associated with the patient contact based on the parsed medical record and based on the parsed patient contact.

7. The apparatus of claim 6 further comprising at least a first treatment provider and a first service provider accessible to the apparatus via the network, and wherein the processor chooses one of the first treatment provider and first service provider responsive to the determined priority level.

8. The apparatus of claim 6 further comprising at least a first service provider and a second service provider accessible to the apparatus via the network, and wherein the processor chooses one of the first service provider and second service provider responsive to the determined priority level.

9. The apparatus of claim 6 wherein the priority is based on one of a number of patient contacts within a predetermined period of time and a length of time between a first message and a second message.

10. The apparatus of claim 1 further comprising an agent configured to transmit a first message to the patient responsive to one of the first treatment provider contact and the first service provider contact, and wherein the first message comprises an estimate of a time period during which one of the first treatment provider and the first service provider initiates contact with the patient.

11. A method of updating a medical record, the method comprising:
receiving, at a central location, a plurality of message destinations, each message destination associated with at least one of a treatment provider and a service provider;
receiving, at the central location, at least a first respective criterion for routing a message to each of the received message destinations based on a comparison between contents of a message and contents of a medical record;
receiving, at the central location, at least a first message, the message including at least one request;
receiving, at the central location, at least a first medical record associated with the patient;
parsing the message responsive to receiving the message;
parsing the medical record responsive to receiving the message;
determining a priority of the message based on the first respective criterion;
routing the message to at least one of the treatment provider and the service provider responsive to the determined priority; and
updating an electronic medical record responsive to the routing.

12. The method of claim 11 wherein the criterion includes a number of patient contacts within a predetermined period of time.

13. The method of claim 11 wherein the criterion includes a length of time between a first message and a second message.

14. The method of claim 11 wherein updating the electronic medical record comprises updating at least one of a time of message receipt, source of message, time of message routing, determined destination, determined priority; response time estimate; response time achieved; and parsed message contents.

15. The method of claim 11 wherein receiving the message comprises receiving a phone call at an answering service and wherein updating an electronic medical record responsive to the routing comprises transcribing the message and writing the transcribed message to the electronic medical record.

16. The method of claim 11 wherein receiving the message comprises at least one of receiving an electronic communication via a packet switched network, receiving an electronic communication via a circuit switched network, and receiving an over the air message.

17. The method of claim 11 wherein updating an electronic medical record responsive to the routing comprises storing a sound file in memory.

18. A method of facilitating contact between a patient and at least one of a service provider and a treatment provider, the method comprising:
receiving, at a central location, a plurality of message destinations, each message destination associated with at least one of a treatment provider and a service provider;
receiving, at the central location, at least a first respective criterion for routing a message to each of the received message destinations based on a comparison between contents of a message and contents of a medical record;
receiving, at the central location, at least a first message, the message including at least one request;
receiving, at the central location, at least a first medical record associated with the patient;
parsing the first message responsive to the receiving;
parsing the medical record responsive to receiving the message;
determining a priority of the message based on the first respective criterion;
routing the message to at least one of the treatment provider and the service provider responsive to the determined priority;
updating an electronic medical record responsive to the routing; and
facilitating a communication between the patient and the one of the service provider and the treatment provider responsive to the routing.

19. The method of claim 18 wherein the criterion includes at least one of a number of patient contacts within a predetermined period of time and a length of time between a first message and a second message.

20. The method of claim 18 further comprising:
updating the medical record based on the facilitated communication.
